(19) United States
(12) Patent Application Publication
(10) Pub. No.: US 2004/0152442 A1
(43) Pub. Date: Aug. 5, 2004

(54) Prepaid cellular telephone system and method

(76) Inventors: Gregory T. Taisto, Green Bay, WI (US); Steven J. Schneider, DePere, WI (US); Shane S. Bassett, Kewaunee, WI (US); Chad Heim, Green Bay, WI (US); Carson Diltz, DePere, WI (US); Timothy D. Bazett-Jones, Green Bay, WI (US); Robert L. Gause, DePere, WI (US); Steven M. Krenek, DePere, WI (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/358,964

(22) Filed: Feb. 5, 2003

(51) Int. Cl. H04M 11/00

(52) U.S. Cl. 455/406; 455/408

(57) ABSTRACT

A prepaid cellular telephone system and a method of providing prepaid cellular telephone services is provided. The telephone system includes a server operatively connected to a local exchange carrier for placing and receiving telephone calls and a handset for placing and receiving telephone calls over a cellular network. All non-emergency calls placed by the handset are direct to the server. In addition, the handset places a telephone call to the server in response to the receipt of an incoming telephone call by the handset. As a result, all non-emergency telephone calls placed or received by the handset may be monitored by the server for billing purposes.

### FIELD OF THE INVENTION

This invention relates generally to cellular telephone systems, and in particular, to a prepaid cellular telephone system and a method of providing a prepaid cellular telephone services to a user.

### BACKGROUND AND SUMMARY OF THE INVENTION

Wireless communication systems, such as cellular telephone networks, have experienced exponential growth in the past few years. Typically, cellular telephone services are sold in a month-to-month or on a contract basis wherein a subscriber pays a fixed, monthly fee in exchange for a predetermined number of airtime minutes. If the subscriber exceeds the number of minutes allocated in the rate plan, the subscriber must pay a surcharge for each additional minute. This surcharge can be significant. Further, for individuals with no credit history or damaged credit history, it may be difficult to find a cellular service provider willing to offer its services.

In view of the foregoing, various types of prepaid cellular services are now being offered by cellular service providers. These prepaid cellular services utilize telephone systems that allow a subscriber to pre-purchase a number of cellular airtime minutes. Thereafter, the cellular service provider monitors the number of minutes used by the subscriber and limits the subscriber to the actual number of minutes pre-purchased. In such manner, the cellular service provider insures that a subscriber pays for the minutes used. In addition, the subscriber has better control of the costs associated with the use of their cellular telephone. More specifically, the subscriber will know the exact amount of money expended on cellular telephone calls.

While prepaid cellular telephone systems work well for users in their home service area, difficulties arise when a user “roams” to a cellular service area outside of a subscriber's home service area. When a subscriber is in his home service area, all telephone calls placed by the subscriber pass through the subscriber's home cellular service provider. As a result, the home cellular service provider may accurately monitor the number of minutes used by the cellular subscriber and, if the subscriber is approaches the prepaid limit, correspondingly restrict and/or terminate the cellular service. This, in turn, limits the cellular service provider's relative exposure. However, when a subscriber roams outside of their home cellular service area, all telephone calls placed by the subscriber are placed through a different cellular service provider. This “foreign” cellular service provider monitors the actual time used by the cellular subscriber and transmits a bill to the home service provider. Unfortunately, due to a time lag associated with the billing by the foreign cellular service provider to the home cellular service provider, it is impossible for the home cellular service provider to monitor in real time the number of airtime minutes used by the cellular subscriber when in a foreign cellular area. Consequently, the home cellular service provider potential exposure to possible abuse or fraud is substantial.

In view of the foregoing, prepaid cellular telephone systems have been developed that allow a cellular service provider to monitor a subscriber's activities when roaming in foreign cellular service areas. By way of example, Fougnies, U.S. Pat. No. 5,778,313 discloses a cellular telephone system that allows prepaid subscribers to complete cellular telephone calls when traveling in foreign cellular service areas. The telephone system disclosed in the Fougnies '313 patent includes a handset that is assigned a virtual or pseudo-number which terminates at a central server, and not at the handset. As such, all telephone calls placed to the virtual number are routed through the central server to the handset. In addition, all outgoing calls from the handset are routed through the central server via a toll free number, regardless of the telephone number dialed by the subscriber. In such a manner, the central server can monitor all outgoing calls from the handset and all incoming calls placed to the virtual number.

While the telephone system disclosed in the Fougnies '313 patent is functional for its intended purpose, the telephone system disclosed therein has certain limitations. By way of example, the handset disclosed in cellular telephone system of the '313 patent accepts all incoming calls. As a result, it is possible that a subscriber may be able to determine the actual telephone number of the handset and bypass the central server. By bypassing the central server, a subscriber to the telephone system disclosed in the '313 patent may avoid payment for all incoming calls. In addition, all outgoing telephone calls placed by the handset in the telephone system of the '313 patent are directed through the central server. As such, certain calls directed to emergency service providers, such as 911, may be delayed or rejected in the event that the subscriber has not purchased sufficient minutes to cover the cost of the telephone call to the emergency provider.

Therefore, it is a primary object and feature of the present invention to provide a prepaid cellular telephone system that allows a user to place and receive cellular telephone calls in a subscriber's home service area, as well as, when the user is roaming in foreign service areas.

It is a further object and feature of the present invention to provide a prepaid cellular telephone system that provides greater safeguards against fraud by a subscriber than prior telephone systems.

It is a still further object and feature of the present invention to provide a prepaid cellular telephone system that allows outgoing telephone calls directly to an emergency service provider regardless of the status of the subscriber's account.

In accordance with the present invention, a prepaid cellular telephone system is provided. The telephone system includes a server operatively connected to a local exchange carrier for placing and receiving telephone calls and a handset for placing and receiving telephone calls over a cellular network. The handset places a telephone call to the server in response to the receipt of an incoming telephone call by the handset.

It is contemplated for the handset to reject all incoming telephone calls. In addition, the handset is assigned a virtual phone number such that when a telephone call is placed to the virtual phone number, the telephone call is actually received by the server.

The handset includes a microprocessor and a dialing mechanism for allowing a user to dial a user selected telephone number and to place a telephone call. The user selected telephone number is selected from the group consisting of an emergency number and a non-emergency number. Each telephone call placed to a non-emergency number by the user of the handset is directed to the server. Each telephone call placed to an emergency number is directed to the cellular network. The microprocessor of the handset generates a data packet in response to the dialing of the user selected number. The data packet includes a system identifier corresponding to the cellular network and a handset identifier to identify the handset.

In accordance with a further aspect of the present invention, a method is provided for selectively providing wireless communication for a user of a cellular phone. The method includes the step of providing an account for the cellular telephone. The account is assigned one of an active status and a restricted status, and has a number of airtime minutes purchasable by the user. A destination telephone number may be dialed with the cellular telephone such that a first telephone call is placed to a central server from the cellular telephone in response to the dialing of the destination number. A data packet is transmitted from the cellular telephone to the central server and the status of the account of the cellular telephone is determined. The first telephone call is terminated if the status of the account is restricted. In addition, the number of airtime minutes is determined for the account of the cellular telephone and the first telephone call is terminated if the number of airtime minutes for the account is less than a predetermined number. A second telephone call is placed from the central server to the destination telephone number if the account status is active and if the number of airtime minutes exceeds the predetermined number. Thereafter, the first telephone call and the second telephone call are interconnected as a connected outgoing telephone call. The connected outgoing telephone call is monitored for billing purposes.

A user can purchase additional number of airtime minutes prior to the step of terminating the first telephone call if the number of airtime minutes for the account is less than a predetermined number. In order for a user to purchase an additional number of airtime minutes, the user must agree to purchase the additional number of airtime minutes, select a mode of payment and pay for the additional number of minutes.

It is contemplated to assign a phantom telephone number to the cellular telephone such that the server receives an incoming call placed to the phantom telephone number. Once the incoming call is received, the status of the account of the cellular telephone is determined and the incoming telephone call is terminated if the status of the account is restricted. In addition, the number of airtime minutes for the account of the cellular telephone is determined and the incoming telephone call is terminated if the number of airtime minutes for the account is less than the predetermined number. If the account status is active and if the number of airtime minutes exceeds the predetermined number, a connection telephone call is placed to the cellular telephone from the central server. The incoming telephone call and the cellular telephone are connected as a connected incoming telephone call. The step of connecting the incoming telephone call to the cellular telephone may include the additional steps of rejecting the connection telephone call by the cellular telephone and placing a response telephone call to the central server with the cellular telephone. Thereafter, the incoming telephone call is accepted by the user of the cellular telephone.

The step of connecting the incoming telephone call to the cellular telephone includes the additional step of monitoring the connected incoming telephone call for billing purposes. As a result, if the number of airtime minutes decreases below the predetermined number, the connected incoming call is terminated. In addition, if the number of airtime minutes decreases below the predetermined number, the connected outgoing call is terminated.

In accordance with a still further aspect of the present invention, a method is defined of selectively providing wireless communication. The method includes the step of providing an account for the cellular telephone. The account is assigned either an active status or a restricted status, and has a number of airtime minutes purchasable by the user. A first telephone call is placed to a central server from the cellular telephone and a data packet is transmitted from the cellular telephone to the central server. The data packet includes a system identifier corresponding to the cellular network and an account identifier for identifying account. The status of the account of the cellular telephone is determined and the first telephone call is terminated if the status of the account is restricted. In addition, the number of airtime minutes for the account of the cellular telephone is determined and the first telephone call is terminated if the number of airtime minutes for the account is less than a predetermined number.

The method includes the additional step of placing a second telephone call from the central server to a destination telephone number if the account status is active and if the number of airtime minutes exceeds the predetermined number. The first telephone call and the second telephone call are interconnected as a connected outgoing telephone call. The connected outgoing telephone call is monitored for billing purposes. It is contemplated that the step of monitoring the connected outgoing telephone call includes the additional step of terminating the connected outgoing telephone call in response to the number of airtime minutes decreasing below the predetermined number. In addition, the step of monitoring the connected outgoing telephone call may also include the additional step of allowing a user to purchase an additional number of airtime minutes prior to the step of terminating the first telephone call if the number of airtime minutes for the account is less than a predetermined number. A user purchases an additional number of airtime minutes by agreeing to purchase the additional number of airtime minutes, selecting a mode of payment and paying for the additional number of minutes.

The cellular telephone is assigned a phantom telephone number such that an incoming telephone call placed to the phantom telephone number is directed to a central server. In response to receiving the incoming telephone call, the central server determines the status of the account of the cellular telephone and terminates the incoming telephone call if the status of the account is restricted. In addition, the central server determines the number of airtime minutes available for the account of the cellular telephone and terminates the incoming telephone call if the number of airtime minutes for the account is less than the predetermined number. If the account status is active and if the number of airtime minutes exceeds the predetermined number, the central server places a connection telephone call to the cellular telephone and connects the incoming telephone call to the cellular telephone as a connected incoming telephone call.

The step of connecting the incoming telephone call to the cellular telephone includes the additional steps of having the cellular telephone reject the connection telephone call, and thereafter, placing the first telephone call to the central server from the cellular telephone. Once connected to the central server, the user of the cellular telephone must accept the incoming telephone call. The connected incoming telephone call is monitored for billing purposes such that the connected incoming telephone call is terminated in response to the number of airtime minutes decreasing below the predetermined number. Alternatively, a user may purchase additional number of airtime minutes prior to the termination of the connected incoming telephone call.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a schematic view of a prepaid cellular telephone system in accordance with the present invention;

FIG. 2 is a flow chart showing the main telephone call loop executed in accordance with the method of the present invention;

FIG. 3 is a flow chart showing the process of placing a telephone call from a handset in accordance with the method of the present invention;

FIG. 4 is a flow chart showing the process for receiving a telephone call with a handset in accordance with the method of the present invention;

FIG. 5 is a flow chart showing the process for paging the handset in accordance with the method of the present invention;

FIG. 6 is a flow chart showing the process for a central server to request data from the handset in accordance with the method of the present invention;

FIG. 7 is a flow chart showing the process for update the number of minutes available for a user of the handset in accordance with the method of the present invention;

FIG. 8 is a flow chart showing the process for purchasing additional minutes for the handset with a credit card in accordance with the method of the present invention; and

FIG. 9 is a flow chart showing the process for purchasing additional minutes for the handset with a predetermined code in accordance with the method of the present invention.

### DETAILED DESCRIPTION OF THE DRAWINGS

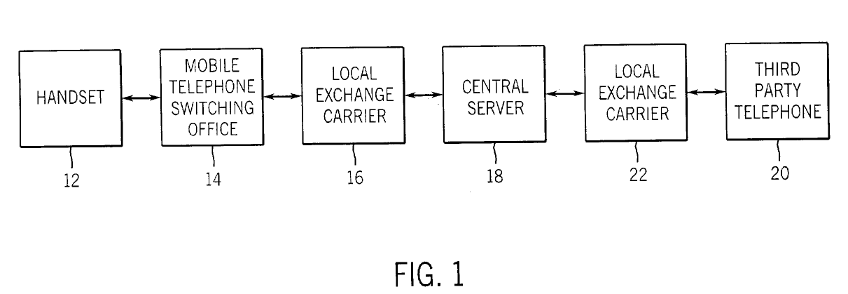

Referring to FIG. 1, a prepaid cellular telephone system in accordance with the present invention is generally designated by the reference numeral 10. By way of example, telephone system 10 includes a handset or cellular telephone 12 for placing and receiving telephone calls over a cellular network. It can be appreciated that additional handsets 12 may be incorporated into telephone system 10 without deviating from the scope of the present invention.

As is conventional, handset 12 includes a microprocessor programmed to effectuate portions of the method of the present invention; a dialing mechanism such as a keypad for allowing a subscriber to enter data such as a telephone number; and a send key to initiate an outgoing telephone call. For reasons hereinafter described, handset 12 is identified by a handset telephone number assigned to central server 18. In addition, handset 12 is assigned an actual telephone number that is known only to the cellular service provider from which airtime minutes for handset 12 must be purchased. Further, the microprocessor of handset 12 is programmed such that all non-emergency telephone calls placed by handset 12 automatically transmit a pseudo-number, e.g., a toll-free number, for central server 18 to mobile telephone switching office 14 and such that handset 12 places a telephone call to the toll-free number for central server 18 in response to receipt of a telephone call at handset 12. If a telephone call is placed to an emergency service provider, such as 911, such telephone number will be transmitted to mobile telephone switching office 14 so as to bypass central server 18.

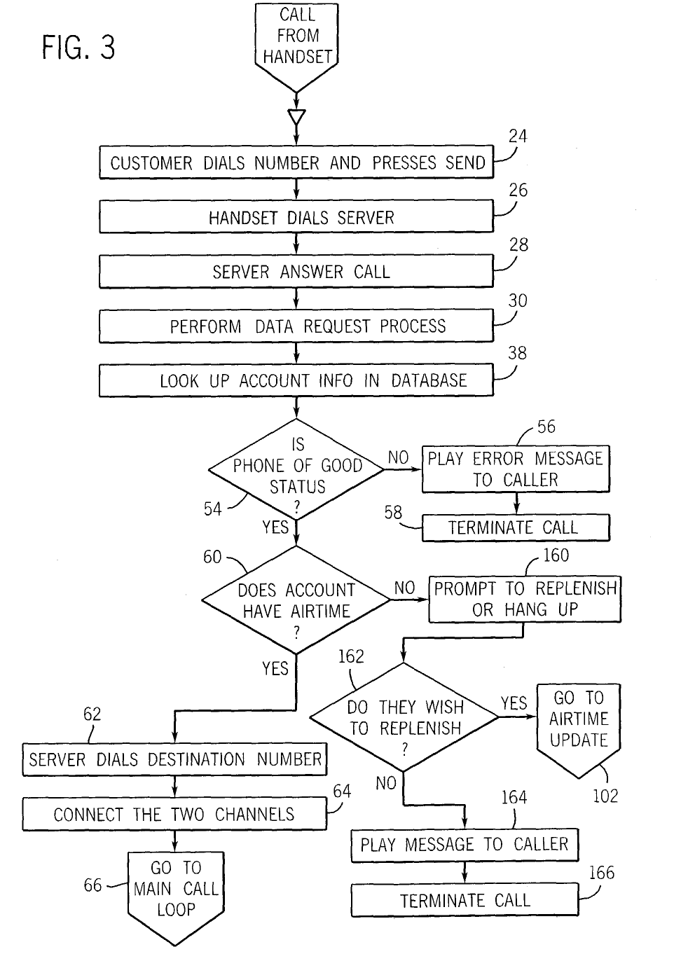

Referring to FIGS. 1 and 3, a subscriber to the cellular service provider initiates a telephone call by entering a desired destination telephone number on the keypad of the dialing mechanism of handset 12 and pressing the send button, block 24. As heretofore described, handset 12 dials the toll free number associated with central server 18, block 26, and the telephone call is transmitted to mobile telephone switching office 14. Mobile telephone switching office 14 passes the telephone call through local exchange carrier 16 to central server 18, which answers the outgoing call, block 28. As hereinafter described, central server 18 interconnects the telephone call received from handset 12 and the telephone call placed to third party telephone 20 if the subscriber has a sufficient number of airtime minutes available to place a telephone call.

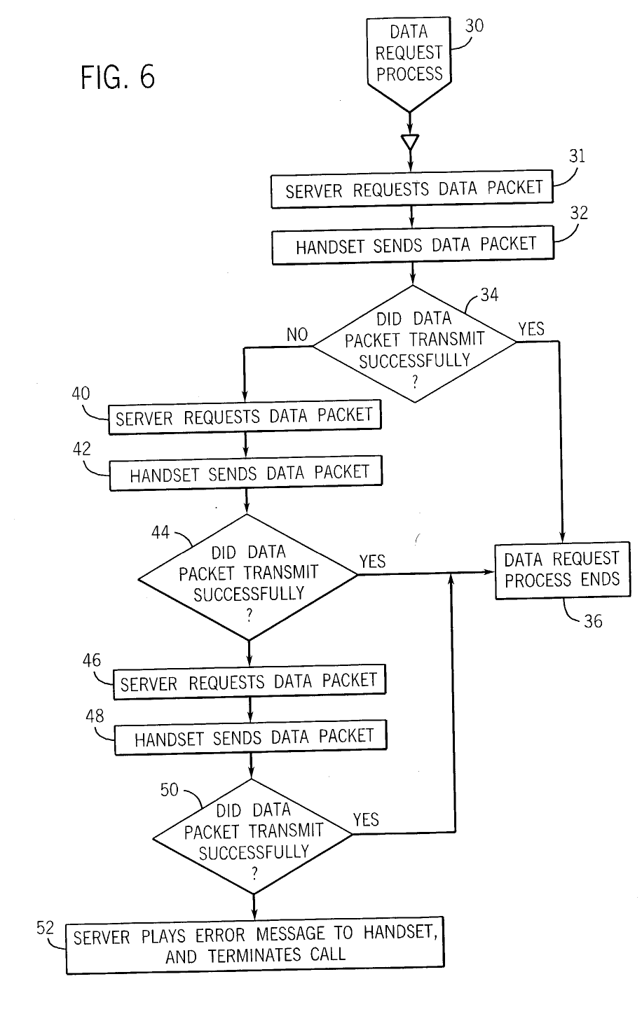

Upon answering the telephone call, central server 18 requests a predetermined data packet from handset 12, block 30. As hereinafter described, central server 18 is programmed to effectuate portions of the method of the present invention and includes a database containing account information for each subscriber to the cellular service provider. Referring to FIG. 6, in response to the central server's request, handset 12 transmits a data packet to central server 18, block 32. The data packet contains the desired designation telephone number dialed by the subscriber, the system identification for the cellular network on which handset 12 is currently operating, and an identification number that identifies handset 12 to central server 18. Thereafter, central server 18 determines if the data packet has been transmitted successfully, block 34. If the data packet was transmitted successfully by handset 12 to central server 18, the data request process is concluded, block 36, and central server 18 looks up the account information corresponding to the identification number received from handset 12, block 38, FIG. 3. If the central server does not successfully receive the data packet, central server 18 will once again request the data packet, block 40, from handset 12. In response, handset 12 resends the data packet, block 42, and central server 18 determines whether such subsequent transmission of the data packet was successful, block 44. If the transmission of the data packet by handset 12 is successful, the data request process is terminated, block 36, and central server 18 looks up the account information corresponding to the identification number received, block 38, FIG. 3. If the transmission of the data packet is not successful received by central server 18, central server 18 will request the data packet from handset 12 for a last time, block 46. Handset 12 once again transmits the data packet, block 48, and central server 18 determines if the data packet was transmitted successfully, block 50. If the data packet was transmitted successfully, the data request process is terminated, block 36, and central server looks up the account information corresponding to the identification number provided in the data packet, block 38, FIG. 3. If the data packet is not transmitted successfully, central server 18 plays an error message to handset 12 and terminates the outgoing call, block 52.

Referring back to FIG. 3, once central server 18 determines the account information, block 38, central server 18 determines the status of handset 12, block 54. For example, if the status of the account corresponding to handset 12 is restricted (i.e., the account was terminated by the subscriber or the cellular service provider), central server 18 will play an error message to the user of handset 12, block 56, and the outgoing telephone call will be terminated by central server 18, block 58. If the status of the subscriber's account is active, central server 18 determines whether the account has sufficient prepaid airtime minutes available for a subscriber to place an outgoing call to the desired designation telephone number, block 60. If the account of the subscriber has sufficient airtime minutes, central server 18 dials the desired designation telephone number, block 62. As best seen in FIG. 1, the telephone call placed by central server 18 passes through local exchange carrier 22 to third party telephone 20. Central server 18 then connects the incoming telephone call received from handset 12 with the outgoing call placed to the desired designation telephone number, block 64. This, in turn, allows the subscriber to hear any busy signal, ring or the like provided by third party telephone 20. Thereafter, central server 18 effectuates the main call subroutine, block 66.

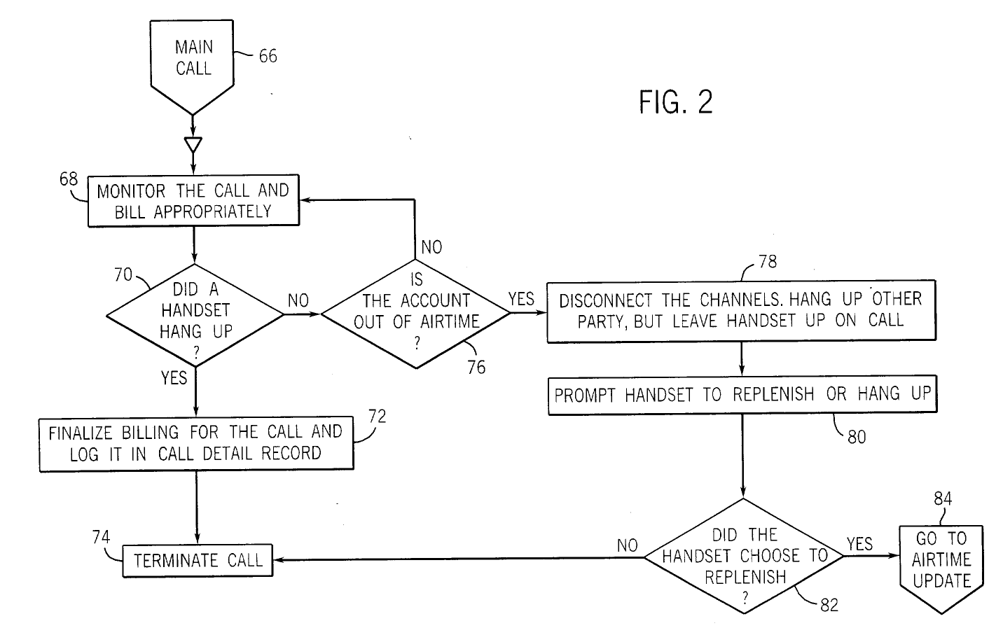

Referring to FIG. 2, once handset 12 is connected to third party telephone 20, central server 18 monitors the telephone call and the amount of airtime minutes used by the subscriber, block 68. As heretofore described, handset 12 provided central server 18 with the system identification for the cellular network on which the call is placed. As such, central server 18 may accurately track the number of airtime minutes used on a “foreign” cellular network in real time, and hence, the cost of the telephone call placed by the subscriber. In addition, central server 18 determines if handset 12 hangs up so as to terminate the connection between handset 12 and third party telephone 20, block 70. If handset 12 terminates the telephone call with third party telephone 20, central server 18 finalizes the billing for the telephone call by recalculating the number of airtime minutes available to the subscriber, block 72, and terminates the call, block 74. If handset 12 is not hung up, central server 18 continually monitors the number of airtime minutes used by the subscriber during the telephone call to insure that the subscriber has a positive balance, block 76. If the subscriber runs out of airtime minutes, central server 18 disconnects handset 12 from third party telephone 20 and hangs up on the connection between third party telephone 20 and central server 18, block 78. However, central server 18 maintains a connection with handset 12. Thereafter, central server 18 prompts handset 12 to either hang up or replenish the number of airtime minutes available for the subscriber's use, block 80, and determines whether or not the subscriber wishes to replenish the number of airtime minutes available for use, block 82. If the subscriber does not wish to replenish the number of airtime minutes available, the telephone call between handset 12 and central server 18 is terminated, block 74. If the subscriber chooses to replenish the number of airtime minutes available, central server 18 executes the airtime update subroutine, block 84.

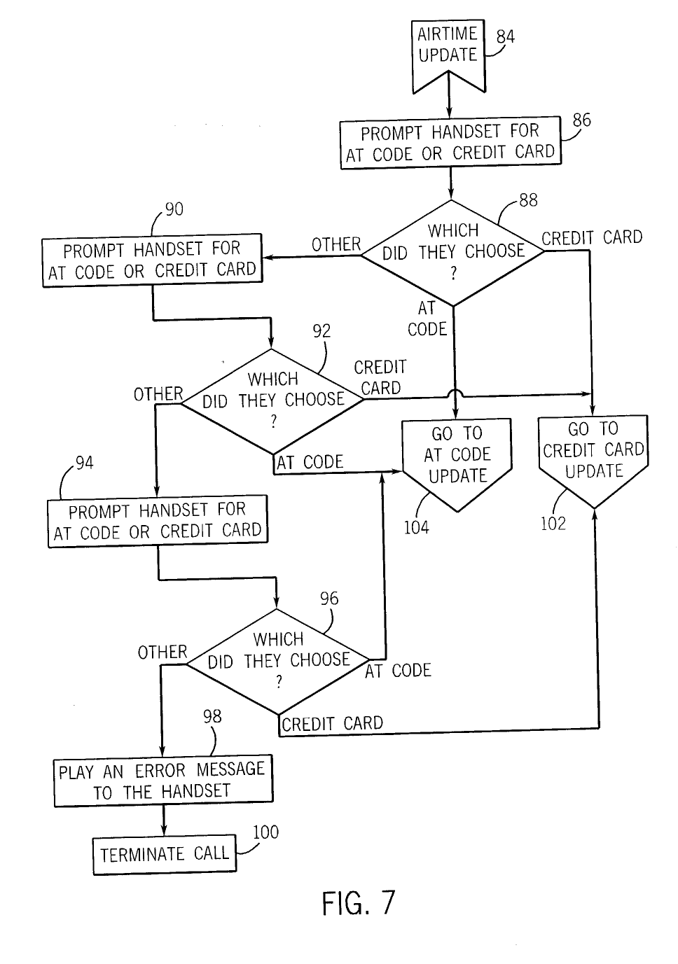

Referring to FIG. 7, in order to allow a subscriber to update the number of airtime minutes available for use, central server 18 prompts handset 12 to enter either an airtime code or a credit card number to purchase the additional airtime minutes, block 86. The airtime code may be provided to a subscriber if the subscriber provides credit card information to the cellular service provider. Thereafter, central server 18 determines which method of payment was chosen by the subscriber, block 88. If the subscriber enters an option other than the airtime code or a credit card, central server 18 prompts the subscriber once again to enter a method of payment, block 90, and determines which method of payment the subscriber chooses, block 92. Again, if the subscriber does not select either an airtime code or a credit card as a method of payment, the central server will prompt the subscriber to select a method of payment, block 94, and determines which method of payment was chosen by the subscriber, block 96. If after three attempts, the subscriber does not chose to update the number of airtime minutes with an airtime code or with a credit card, central server 18 plays an error message, block 98, and terminates the telephone call, block 100. If the subscriber chooses to update the number of airtime minutes available by credit card, central server 18 proceeds to execute the credit card subroutine, block 102. If the subscriber chooses to replenish the number of minutes available using an airtime code, central server 18 executes the airtime code subroutine, block 104.

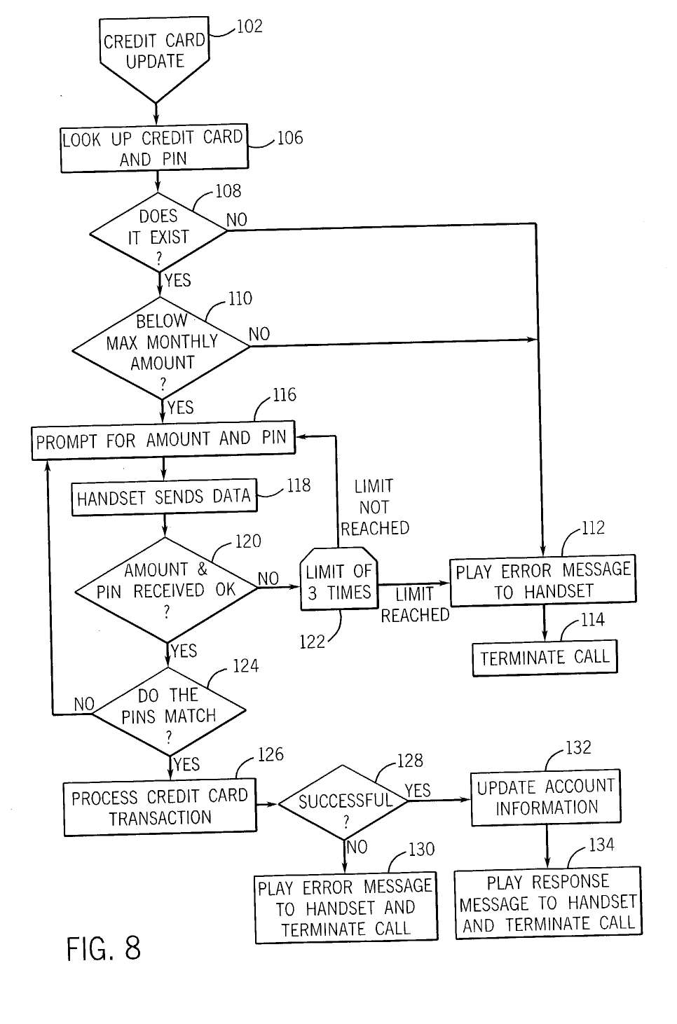

Referring to FIG. 8, if a subscriber chooses to update the number of airtime minutes available by credit card, central server 18 looks up the credit card number and pin number for the credit card entered by the subscriber, block 106. Thereafter, central server 18 determines whether credit card number and the pin number is valid, block 108, and if the subscriber is below the available credit line for the credit card, block 110. If the credit card number and pin number for the credit card entered is not valid, or if the user has exceeded the credit limit on the credit card, central server 18 plays an error message, block 112, and the telephone call is terminated, block 114. If the credit card number and pin number for the credit card entered is valid and if the subscriber is below the credit limit for the credit card, central server 18 prompts the user to enter a dollar amount to purchase a number of airtime minutes and requests the pin number for the credit card, block 116.

In response to the prompt from central server 18, a subscriber sends the information to the central server by entering such information on the keypad of handset 12, block 118. Central server 18 determines whether the dollar amount and pin number have been received, block 120. If the dollar amount and pin number have not been received by central server 18, the process is repeated up to three times, block 122, so as to allow the subscriber to accurately enter the information requested. If the subscriber does not accurately enter the information after three attempts, central server 18 plays an error message, block 112, and the telephone call is terminated, block 114. In addition, central server 18 determines if the pin number entered by the subscriber corresponds to the credit card pin number previously entered by the subscriber. If the pin number received by the central server 18 does not correspond to the pin number for the credit card previously entered, central server 18 returns to the step of prompting the subscriber to enter the dollar amount the subscriber wishes to purchase and the pin number for the credit card, block 116. If the pin number entered by the subscriber matches the pin number for the credit card, central server 18 processes the credit card transaction, block 126, and determines if the credit card transaction is successful, block 128. If the credit card transaction is not successful, central server 18 plays an error message and terminates the telephone call, block 130. If the credit card transaction is successful, central server 18 updates the account information, including the number of airtime minutes available, block 132, plays an acknowledgement message, and terminates the telephone call, block 134.

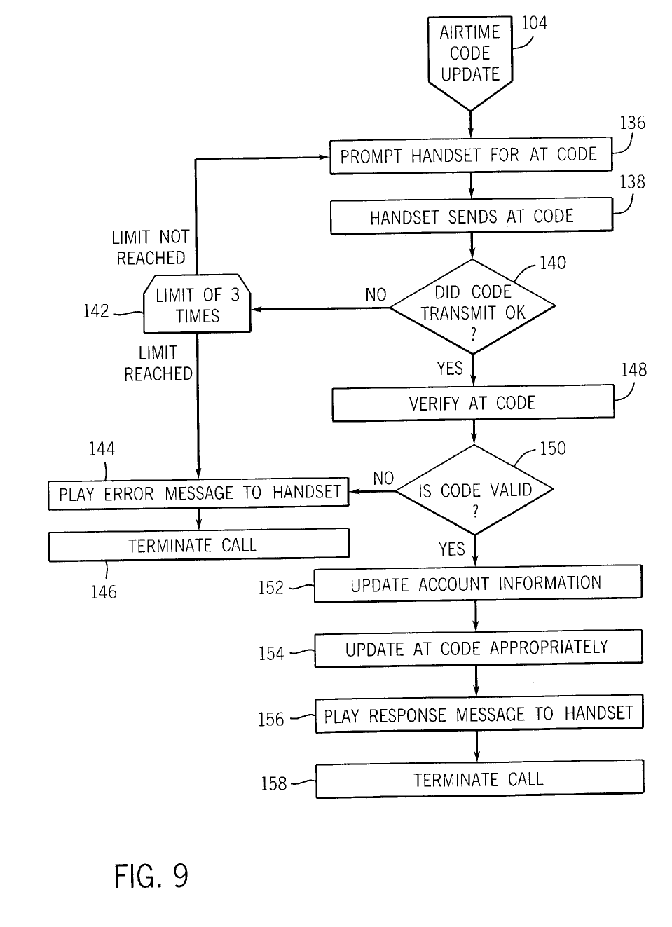

Referring to FIG. 9, if the subscriber chooses to replenish the number of airtime minutes available by using an airtime code, central server 18 will prompt the subscriber for the airtime code, block 136. Thereafter, the subscriber sends the airtime code to central server 18 by dialing such airtime code on the keypad of handset 12, block 138 and central server 18 determines if the airtime code was transmitted correctly, block 140. If the airtime code was not transmitted correctly, the process is repeated up three times to allow a user to accurately enter the airtime code, block 142. If, after three attempts, the airtime code is not received by central server 18, central server 18 plays an error message, block 144, and terminates the telephone call, block 146. If the airtime code is received by central server 18, central server attempts to verify the airtime code, block 142, by determining if the airtime code is valid, block 150. If the airtime code is not valid, central server 18 plays an error message, block 144, and the call is terminated, block 146. If the airtime code is validated, central server 18 updates account information of the subscriber, including the number of airtime minutes available, block 152, and updates the airtime code, if appropriate, block 154. Thereafter, central server, plays an acknowledgement message to the subscriber, block 156, and terminates the telephone call, block 158.

Referring back to FIG. 3, if the account does not have airtime available when the telephone call is placed to the desired designation telephone number, central server 18 will ask the subscriber whether the subscriber wishes to replenish the number of airtime minutes available to the subscriber or if the subscriber wishes to hang up, block 160. Thereafter, central server 18 determines whether the subscriber wishes to replenish the number of airtime minutes available, block 162. If the user does not wish to replenish the number of airtime minutes available, central server 18 plays a message confirming the subscriber's intention, block 164, and terminates the telephone call, block 166. If the subscriber wishes to replenish a number of error time minutes available, central server 18 proceeds to the airtime update subroutine, block 102, as heretofore described.

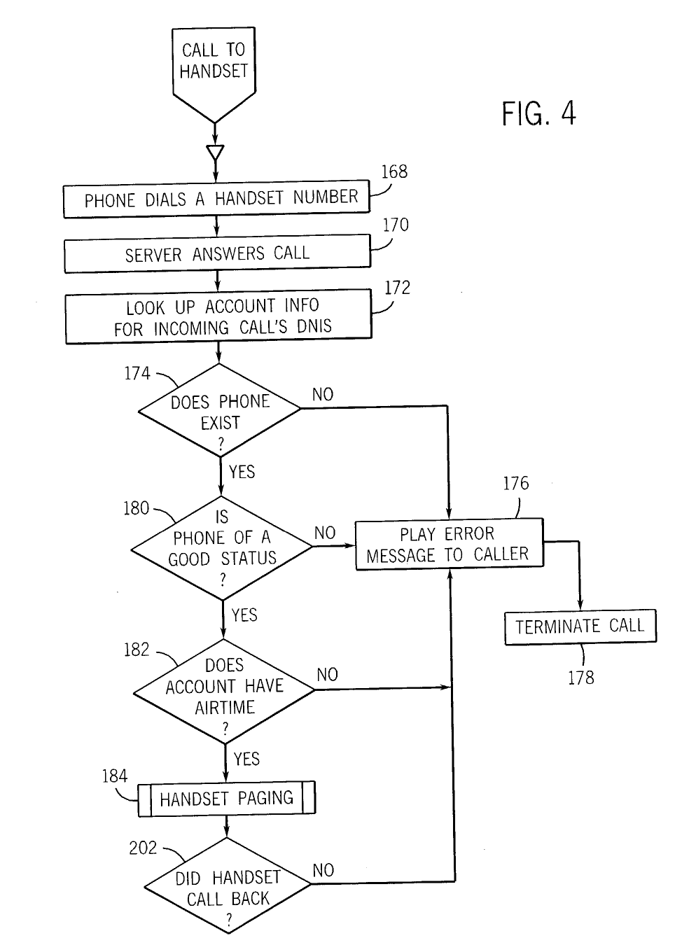

Referring to FIG. 4, in order for a third party to place a telephone call to handset 12, the third party dials a handset telephone number on third party telephone 20, block 168. The telephone call passes through local exchange carrier 22 to central server 18 which answers the telephone call, block 170. Based upon the telephone number dialed by the third party, central server 18 looks up the account information for handset 12 corresponding to such telephone number, block 172, and determines if a handset exists corresponding to the telephone number dialed by the third party, block 174. If no handset exists corresponding to the telephone number dialed by the third party, central server 18 plays an error message for the third party, block 176, and terminates the telephone call, block 178. If central server 18 determines that handset 12 exists corresponding to the telephone number dialed by the third party, central server 18 determines the status of the account corresponding to handset 12, block 180, and determines whether the subscriber corresponding to handset 12 has any airtime minutes available, block 182. If central server 18 determines the account has a rejected status or if the account does not have sufficient number of airtime minutes available to receive the telephone call, central server 18 plays an error message to the third party, block 176, and terminates the telephone call, block 178.

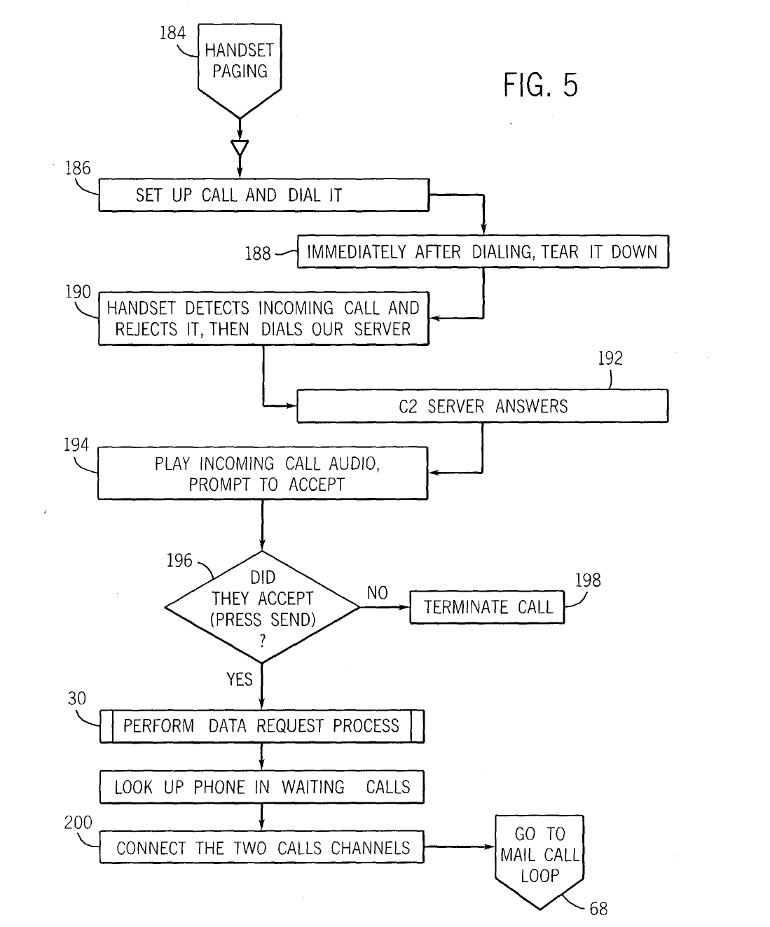

If the subscriber account is in good status and if the user has a sufficient number of airtime minutes available, central server 18 pages handset 12, block 184. It is contemplated for central server 18 to play advertising to the third party during the paging of handset 12. Referring to FIG. 5, central server 18 determines the actual telephone number of handset 12 and dials such telephone number, block 186. Immediately after dialing the number, central server 18 tears down such telephone call so as to minimize the possibility that an unauthorized third party can determine the actual telephone number of handset 12, block 188. The telephone call placed by central server 18 passes through local exchange carrier 16 which transfers the telephone call to mobile telephone switching office 14 that authenticates the telephone call and pages handset 12. The microprocessor of handset 12 is programmed to detect a incoming telephone calls and to immediately reject the same, block 190. This prevents a subscriber from receiving any incoming telephone calls and bypassing central server 18. Thereafter, the microprocessor of handset 12 is programmed to place a telephone call to central server 18, as heretofore described. Central server 18 answers the telephone call from handset 12, block 192, and plays an audio message prompting the subscriber to accept or reject the telephone call from the third party, block 194. The audio message may include information regarding the incoming call such as the telephone number of the third party telephone on which the third party placed the telephone call. Central server determines if the subscriber has accepted or rejected the call from the third party, block 196. If the subscriber rejects the incoming call, central server 18 terminates the telephone call from the third party, block 198. If the subscriber accepts the incoming telephone call, central server 18 performs the data request process, block 30, as heretofore described. Upon completion about the data request process, block 30, central server 18 interconnects the telephone call from handset 12 to central server 18 and the incoming telephone call from third party telephone 20 to central server 18, block 200. Thereafter, central server 18 proceeds to the main call loop, block 68. Referring back to FIG. 4, if the handset does not call back in response to the telephone call from central server 18, block 202, central server 18 plays an error message to the third party caller, block 176, and the incoming call from third party telephone 20 is terminated, block 178.

Various modes of carrying out the invention are contemplated as being within the scope of the following claims particularly pointing out and distinctly claiming the subject matter which is regarded as the invention.

We claim:

1. A prepaid cellular telephone system, comprising:
a server operatively connected to a local exchange carrier for placing and receiving telephone calls; and
a handset for placing and receiving telephone calls over a cellular network, the handset placing a telephone call to the server in response to the receipt of an incoming telephone call by the handset.

2. The telephone system of claim 1 wherein the handset rejects all incoming telephone calls received.

3. The telephone system of claim 1 wherein the handset is assigned a virtual phone number, wherein a telephone call placed to the virtual phone number is received by the server.

4. The telephone system of claim 1 wherein the handset includes a dialing mechanism for allowing a user to dial a user selected telephone number and to place a telephone call.

5. The telephone system of claim 4 wherein the user selected telephone number is selected from the group consisting of an emergency number and a non-emergency number.

6. The telephone system of claim 5 wherein each telephone call placed to a non-emergency number by the user of the handset is directed to the server.

7. The telephone system of claim 5 wherein each telephone call placed to an emergency number is directed to the cellular network.

8. The telephone system of claim 4 wherein the handset includes a microprocessor, the microprocessor generating a data packet in response to the dialing of the user selected number.

9. The telephone system of claim 8 wherein the data packet includes a system identifier corresponding to the cellular network and a handset identifier to identify the handset.

10. A method of selectively providing wireless communication for a user of a cellular phone, comprising the steps of:
providing an account for the cellular telephone, the account assigned one of an active status and a restricted status and having a number of airtime minutes purchasable by the user;
dialing a destination telephone number with the cellular telephone;
placing a first telephone call to a central server from with the cellular telephone in response to the dialing of the destination number;
transmitting a data packet from the cellular telephone to the central server;
determining status of the account of the cellular telephone and terminating the first telephone call if the status of the account is restricted;
determining if the number of airtime minutes for the account of the cellular telephone and terminating the first telephone call if the number of airtime minutes for the account is less than a predetermined number;
placing a second telephone call from the central server to the destination telephone number if the account status is active and if the number of airtime minutes exceeds the predetermined number;
interconnecting the first telephone call and the second telephone call and providing the same as a connected outgoing telephone call; and
monitoring the connected outgoing telephone call for billing purposes.

11. The method of claim 10 comprising the additional step of allowing a user to purchase additional number of airtime minutes prior to the step of terminating the first telephone call if the number of airtime minutes for the account is less than a predetermined number.

12. The method of claim 11 wherein the step of allowing a user to purchase an additional number of airtime minutes comprises the additional steps of:
agreeing to purchase the additional number of airtime minutes;
selecting a mode of payment; and
paying for the additional number of minutes.

13. The method of claim 10 comprising the additional steps of:
assigning a phantom telephone number to the cellular telephone;
receiving at the server an incoming call placed to the phantom telephone number;
determining status of the account of the cellular telephone and terminating the incoming telephone call if the status of the account is restricted;
determining the number of airtime minutes for the account of the cellular telephone and terminating the incoming telephone call if the number of airtime minutes for the account is less than the predetermined number;
placing a connection telephone call to the cellular telephone from the central server if the account status is active and if the number of airtime minutes exceeds the predetermined number; and
connecting the incoming telephone call and to the cellular telephone and providing the same as a connected incoming telephone call.

14. The method of claim 13 wherein the step of connecting the incoming telephone call to the cellular telephone includes the additional steps of:
rejecting the connection telephone call by the cellular telephone;
placing a response telephone call to the central server with the cellular telephone; and
accepting the incoming telephone call by the user of the cellular telephone.

15. The method of claim 14 wherein the step of connecting the incoming telephone call to the cellular telephone includes the additional step of monitoring the connected incoming telephone call for billing purposes.

16. The method of claim 15 wherein the connected incoming call is terminated if the number of airtime minutes decreases below the predetermined number.

17. The method of claim 10 wherein the connected outgoing call is terminated if the number of airtime minutes decreases below the predetermined number.

18. A method of selectively providing wireless communication, comprising the steps of:
providing an account for the cellular telephone, the account assigned one of an active status and a restricted status and having a number of airtime minutes purchasable by the user;
placing a first telephone call to a central server from the cellular telephone;
transmitting a data packet from the cellular telephone to the central server, the data packet including a system identifier corresponding to the cellular network and an account identifier for identifying account;
determining status of the account of the cellular telephone and terminating the first telephone call if the status of the account is restricted; and
determining if the number of airtime minutes for the account of the cellular telephone and terminating the first telephone call if the number of airtime minutes for the account is less than a predetermined number.

19. The method of claim 18 comprising the additional steps of:
placing a second telephone call from the central server to a destination telephone number if the account status is active and if the number of airtime minutes exceeds the predetermined number;
interconnecting the first telephone call and the second telephone call and providing the same as a connected outgoing telephone call; and
monitoring the connected outgoing telephone call for billing purposes.

20. The method of claim 19 wherein the step of monitoring the connected outgoing telephone call includes the step of terminating the connected outgoing telephone call in response to the number of airtime minutes decreasing below the predetermined number.

21. The method of claim 20 wherein the step of monitoring the connected outgoing telephone call includes the additional step of allowing a user to purchase additional number of airtime minutes prior to the step of terminating the first telephone call if the number of airtime minutes for the account is less than a predetermined number.

22. The method of claim 21 wherein the step of allowing a user to purchase an additional number of airtime minutes comprises the additional steps of:
agreeing to purchase the additional number of airtime minutes;
selecting a mode of payment; and
paying for the additional number of minutes.

23. The method of claim 18 comprising the additional step of assigning the cellular telephone a phantom telephone number such that an incoming telephone call placed to the phantom telephone number is directed to a central server.

24. The method of claim 23 comprising the additional steps of:
determining status of the account of the cellular telephone and terminating the incoming telephone call if the status of the account is restricted;
determining the number of airtime minutes for the account of the cellular telephone and terminating the incoming telephone call if the number of airtime minutes for the account is less than the predetermined number;
placing a connection telephone call to the cellular telephone from the central server if the account status is active and if the number of airtime minutes exceeds the predetermined number; and
connecting the incoming telephone call and to the cellular telephone and providing the same as a connected incoming telephone call.

25. The method of claim 24 wherein the step of connecting the incoming telephone call to the cellular telephone includes the additional steps of:
rejecting the connection telephone call by the cellular telephone;
returning to the step of placing the first telephone call to the central server from the cellular telephone; and
accepting the incoming telephone call by a user of the cellular telephone

26. The method of claim 25 wherein the step of connecting the incoming telephone call to the cellular telephone includes the additional step of monitoring the connected incoming telephone call for billing purposes.

27. The method of claim 26 wherein the step of monitoring the connected incoming telephone call includes the step of terminating the connected incoming telephone call in response to the number of airtime minutes decreasing below the predetermined number.

28. The method of claim 27 wherein the step of monitoring the connected incoming telephone call includes the additional step of allowing a user to purchase additional number of airtime minutes prior to the step of terminating the connected incoming telephone call if the number of airtime minutes for the account is less than a predetermined number.
